(19) United States
(12) Patent Application Publication
(10) Pub. No.: US 2012/0069974 A1
(43) Pub. Date: Mar. 22, 2012

(54) TEXT-TO-MULTI-VOICE MESSAGING SYSTEMS AND METHODS

(75) Inventors: Zhongwen Zhu, Saint-Laurent (CA); Basel Ahmad, Montreal (CA)

(73) Assignee: TELEFONAKTIEBOLAGET L M ERICSSON (PUBL), Stockholm (SE)

(21) Appl. No.: 12/887,340

(22) Filed: Sep. 21, 2010

(51) Int. Cl. H04M 11/00

(52) U.S. Cl. 379/88.14

(57) ABSTRACT

Exemplary embodiments describe systems and methods which provide for conversion of a text message into multiple voices. An end user is able to select different voices for translating different portions of a text message. The voices can be selected from among the end user's contacts. Translation from text to voice can be performed locally, i.e., in the end user's terminal device, or in the network.

### TECHNICAL FIELD

The present invention relates generally to communications systems and in particular to methods and systems for converting a text message into a voice message.

### BACKGROUND

As technology advances, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications.

To accommodate the new and different ways in which IP networks are being used to provide various services, new network architectures are being developed and standardized. One such development is the Internet Protocol Multimedia Subsystem (IMS). IMS is an architectural framework which uses a plurality of Internet Protocols (IP) for delivering IP multimedia services to an end user. A goal of IMS is to assist in the delivery of these services to an end user by having a horizontal control layer which separates the service layer and the access layer. IMS provides a standardized way to deliver telephony, data and multimedia conferencing services over fixed and mobile IP networks.

IMS uses Session Initiation Protocol (SIP) as its signaling protocol to establish, tear-down and modify sessions between the users. The Call Session Control Function (CSCF) is an IMS node residing in the control layer, and the CSCF coordinates the multimedia sessions within IMS networks. A SIP Application Server (AS) is a node residing in the service layer; and the SIP AS executes the different services. Most multimedia services result in establishing media streams between the participants and/or network nodes. The media path from the originator to the recipient may include zero or more intermediary network nodes. In IMS, media streams are often carried over signals using Message Session Relay Protocol (MSRP). The entity that controls media delivery is called a Media Resource Function Controller (MRFC). An MRFC issues commands to Media Resource Function Processing (MRFP) entities regarding how to mix and deliver media streams. IMS also allows a service provider to charge for their services based upon subscriber profiles and enables so called “service composition”—i.e., the ability to create a service using multiple simple services as building blocks. Service providers constantly strive to deliver novel services to the end-users in order to set themselves apart from the competition.

One such service is text-to-speech translation. Text to speech translation is a service in which a speech synthesizer (implemented in either software, hardware or some combination thereof) produces speech from a piece of text provided to the synthesizer as input. The resulting voice message is then delivered to a recipient (instead of the text). The quality of the produced speech is judged based on how accurate of a translation the speech output is relative to the text input, and whether the speech output can be easily understood by a person listening to it after the voice message has been delivered.

Multiple techniques exist to achieve text-to-speech translation. Some of these techniques involve a database that stores samples of recorded speech. Other text-to-speech translation techniques use an acoustic model to create a waveform of artificial speech using parameters such as frequency and voice levels.

It would be desirable to provide other text-to-speech services to, for example, enable service providers to further differentiate their service offerings and to provide end users with interesting new communication services.

### SUMMARY

Exemplary embodiments describe systems and methods which provide for conversion of a text message into multiple voices. An end user is able to select different voices for translating different portions of a text message. The voices can be selected from among the end user's contacts. Translation from text to voice can be performed locally, e.g., in the end user's terminal device, or in the network.

According to one exemplary embodiment, a method for transmitting a text-to-voice message includes the steps of receiving, at an end user terminal device, a text message as a first input, receiving, at the end user terminal device, a second input which indicates selection of at least one portion of the text message, receiving, at the end user terminal device, a third input which associates a first voice of a selected first contact of the end user terminal device with the at least one portion of the text message, and transmitting the at least one portion of the text message, information indicating the association between the first voice and the at least one portion of the text message and an identifier of the first contact toward an entity for translation of the at least one portion of the text message into at least one audio segment using the first voice.

According to another exemplary embodiment, a terminal device includes a memory device configured to store a plurality of contacts, and a processor configured to receive a text message as a first input, a second input which indicates selection of at least one portion of the text message, and a third input which associates a first voice of a first selected contact with the at least one portion of said text message, wherein the processor is further configured to transmit the at least one portion of the text message, information indicating the association between the first voice and the at least one portion of the text message and an identifier of the first selected contact toward an entity for translation of the at least one portion of the text message into at least one audio segment using the first voice.

According to yet another exemplary embodiment, a method for processing a text-to-voice message includes the steps of receiving, at a server, a request message from a user for translating a text message into a voice message, the request message including (a) at least one first text portion, (b) an identity of a first contact of the user whose first voice is to be used to translate the at least one first text portion, (c) at least one second text portion, and

(d) an identity of a second contact of the user whose second voice is to be used to translate the at least one second text portion, and obtaining, responsive to the request message, a voice message including a first voice portion corresponding to the first text portion using the first voice associated with the first contact, and a second voice portion corresponding to the second text portion using the second voice associated with second contact.

According to still another exemplary embodiment, a text-to-multi-voice translation server includes a database configured to store voice samples, an interface configured to receive a request message from a user for translating a text message into a voice message, the request message including: (a) a first text portion, (b) an identity of a first contact of the user whose first voice is to be used to translate the first text portion, (c) a second text portion, and (d) an identity of a second contact of said user whose second voice is to be used to translate the second text portion, and a processor configured to obtain, responsive to the request message, a voice message including a first voice portion corresponding to the first text portion using the first voice associated with the first contact, and a second voice portion corresponding to the second text portion using the second voice associated with the second contact.

According to a still further exemplary embodiment, a database stored on a computer system includes an address book containing a plurality of contacts, at least one contact including contact information having one or more voice samples associated with the contact.

### BRIEF DESCRIPTION OF THE DRAWINGS

The accompanying drawings illustrate exemplary embodiments, wherein:

FIGS. 1(a)-1(c) illustrate aspects of a text-to-multi-voice service at an end user terminal according to an exemplary embodiment;

FIG. 2 illustrates an exemplary text-to-multi-voice system according to an exemplary embodiment;

FIG. 3 is a signaling diagram illustrating systems and methods text-to-multi-voice messaging according to exemplary embodiments;

FIG. 4 illustrates an XML body of a request message for text-to-multi-voice messaging according to exemplary embodiment;

FIG. 5 depicts an exemplary network address book configuration according to an exemplary embodiment;

FIG. 6 shows an exemplary end user terminal according to another exemplary embodiment;

FIG. 7 is a flow chart depicting a method for transmitting a text-to-multi-voice message from an end user terminal according to an exemplary embodiment;

FIG. 8 illustrates an exemplary server according to an exemplary embodiment; and

FIG. 9 is a flow chart depicting a method for processing a text-to-multi-voice message according to an exemplary embodiment.

ACRONYM LIST

| | |
|---|---|
| A/D | Analog-to-Digital |
| AS | Application Server (a SIP node) |
| B2BUA | Back to Back User Agent |
| CD-ROM | Compact Disk-Read Only Memory |
| CRT | Cathode Ray Tube |
| CSCF | Call Session Control Function |
| D/A | Digital-to-Analog |
| DSP | Digital Signal Processor |
| DVD | Digital Video Disk |
| EPROM | Erasable Programmable Read Only Memory |
| GAN | Generic Access Network |
| GSM | Global System for Mobile communications |
| HTTP | Hypertext Transport Protocol |
| IMS | IP Multimedia System |
| MMS | Multimedia Messaging Service |
| LCD | Liquid Crystal Display |
| LRRH | Little Red Riding Hood |
| MRFC | Media Resource Function Controller |
| MRFP | Media Resource Function Processor |
| MSRP | Message Session Relay Protocol |
| NAB | Network Address Book |
| OMA | Open Mobile Alliance |
| PCC | Personal Card of a NAB Contact |
| PDA | Personal Digital Assistant |
| PROM | Programmable Read Only Memory |
| RAM | Random Access Memory |
| ROM | Read Only Memory |
| SIM | Subscriber Identity Module |
| SIP | Session Initiation Protocol |
| SMS | Short Messaging Service |
| T2MV | Text-to-Multi-Voice Service |
| T2MV-AS | A SIP AS that orchestrates the T2MV service |
| URI | Uniform Resource Indicator |
| WIM | Wireless Interface Module |
| XML | Extensible Markup Language |
| XCAP | XML Configuration Access Protocol |

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

According to exemplary embodiments, systems, methods, devices and software provide a service which allows a sender to deliver a voice message to a destination, where the voice message is generated from input text and one or more voice samples associated with one or more contacts in the sender's address book. The sender is, for example, able to select different contacts' voices which are to be used to translate different portions of the input text into respective voice segments using their different voices. This service, referred to sometimes herein as a “Text-to-Multi-Voice” (T2MV) service, thus allows a sender to compose a text message that will be translated into an audio message, using one or multiple voices which can be associated with contacts in the sender's address book. The translation may be performed by the network, or may be performed locally, e.g., in the sender's user terminal. Then, the audio message is delivered to its destination in any desired manner, e.g., as a traditional voice call, voice mail or video voice mail, etc.

Consider the following illustrative example of a T2MV service according to an exemplary embodiment. Suppose that an end user wants to send a voice dialogue between Little Red Riding Hood (LRRH) and the Wolf to a young relative using voices that would be familiar to the young relative as, e.g., a bedtime story. Using a T2MV service according to exemplary embodiments, the end user could input as text the dialogue between LRRH and the Wolf, and then specify that Aunt Alice's voice be used for translating the LRRH portion of the dialogue and that Uncle Bob's voice be used for translating the Wolf's portion of the dialogue. The different portions of the text message are then translated to voice using the voice samples of Aunt Alice and Uncle Bob for the corresponding text portions, and the resulting voice message can then be delivered to the young relative using any desired delivery mechanism such that the young user can output the audio message and hear the dialogue in the voices of Aunt Alice and Uncle Bob.

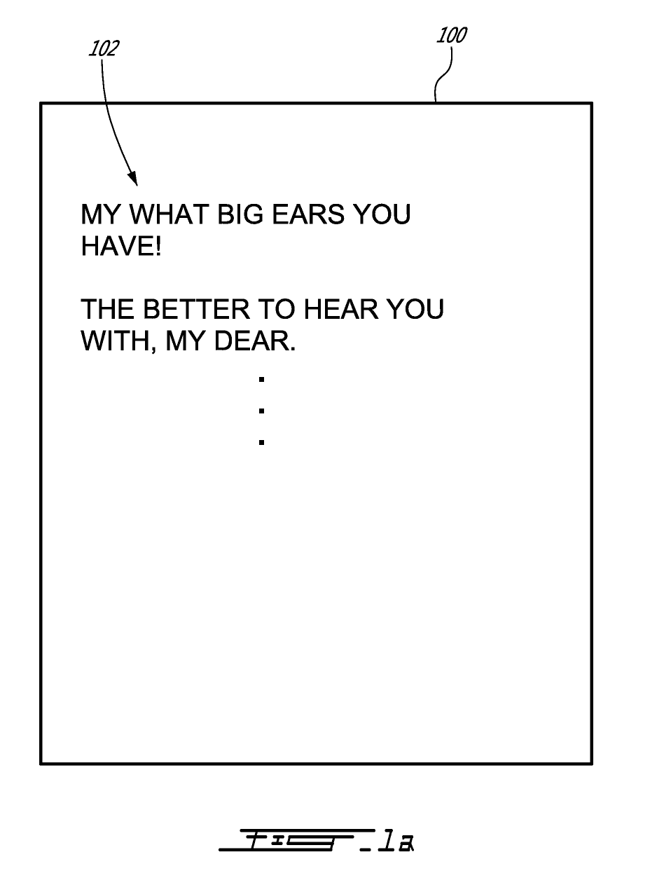

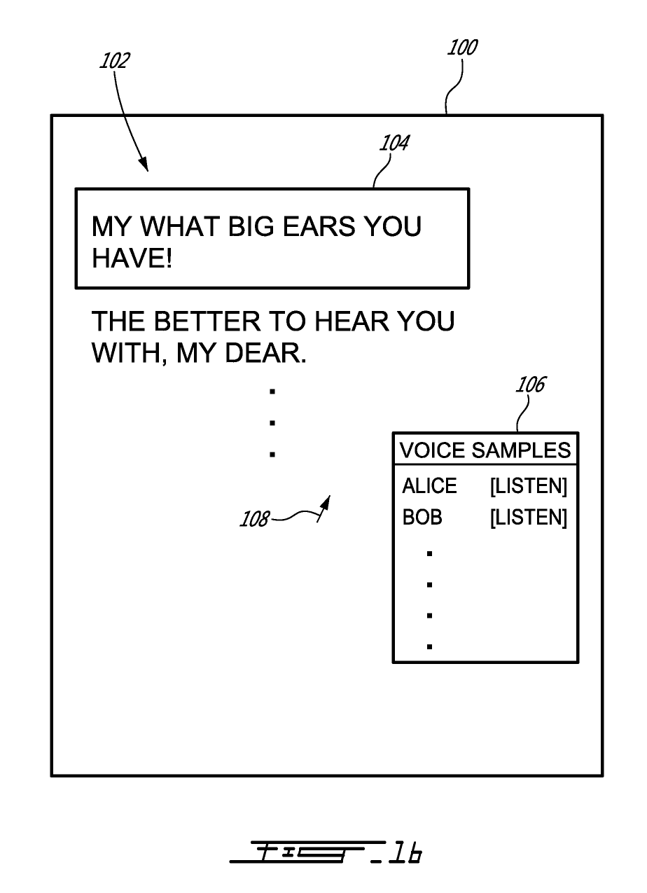

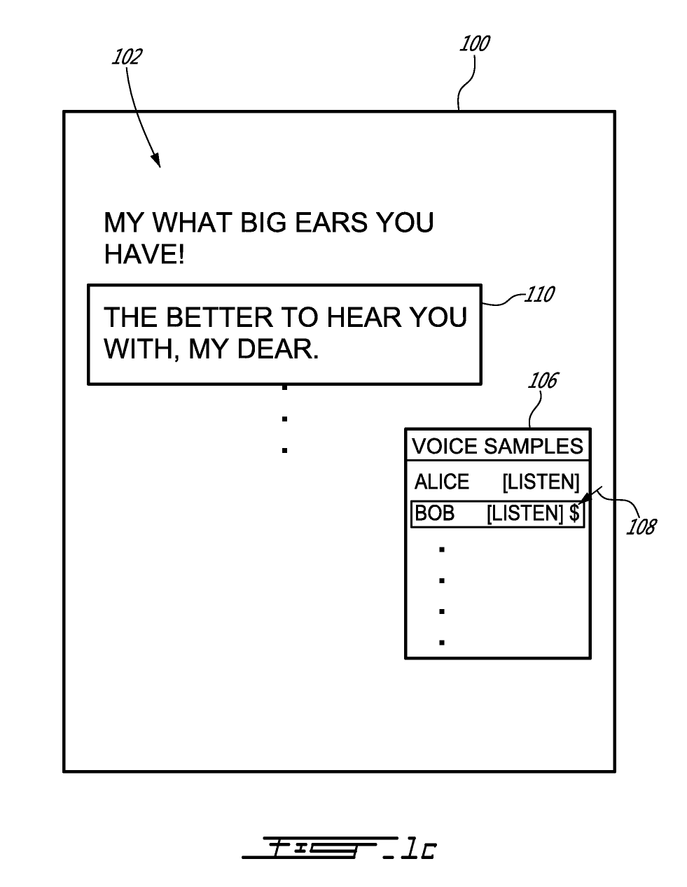

Starting first with a discussion of the client side and T2MV message creation according to exemplary embodiments, an end user can initiate message creation by, for example, launching a T2MV application on his or her end user terminal device, e.g., a mobile phone. Although a mobile phone is used herein as one example of an end user device on which a T2MV message can be created, it will be appreciated by those skilled in the art that any suitable device, e.g., personal computer, PDA, television, etc., could be used as such an end user device for T2MV message creation. Launching the T2MV application can, for example, result in the display of a text window 100 in which the end user can enter the text associated with the T2MV message being created, e.g., exemplary text 102 as shown in FIG. 1(a). After entering the text into window 100, the end user is then able to select one or more portions of the text for association with a particular voice. For example, as shown in FIG. 1(b), an end user can highlight a text segment 104 which he or she would like to translate into an audio message using a particular voice sample from the contacts in his or her address book by providing a suitable input to the user interface of the terminal device.

After highlighting or otherwise selecting the desired text segment(s), a pop-up window 106 for T2MV service is displayed for voice selection. In this purely illustrative example, the window 106 may include all of the contacts in the end user's address book, the subset of those contacts who have the capability to provide their voice services or the subset of those contacts which permit their voices to be used for the T2MV service. The voice selection user interface element 106 may also include, for example, an option for the end user to listen to a voice sample associated with a contact to aid in the selection of a particular voice for a particular text segment and/or an indication of whether there is a fee associated with the selection of a voice sample.

It will be appreciated by those skilled in the art that there are many ways in which an association can be generated between a particular text segment of message and a particular contact or voice in the end user's address book and that the foregoing discussion associated with FIGS. 1(a) and 1(b) are only intended as an example. Once the end user selects a particular contact's voice to associate with the highlighted text segment 104, e.g., by moving cursor 108 over Alice's contact name in window 106 and providing a selection input, the pop-up window 106 can disappear. The end user device then stores or otherwise retains the association between the selected text segment and the selected contact for subsequent processing as described below.

This selection process can be repeated to associate other text segments in the message with other contacts or voices from the end user's local address book. For example, as shown in FIG. 1(c), a second text segment 110 can be highlighted or otherwise selected by an end user. Then, the end user can select Bob's voice, e.g., using the pop-up window 106, cursor 108 and a selection input, to be used for translation of this second text segment 110. This process can continue until all of the text 102 in the message is associated with a contact in the end user's address book. Text for which the end user establishes no association in a T2MV message can, for example, be designated for translation using a default voice.

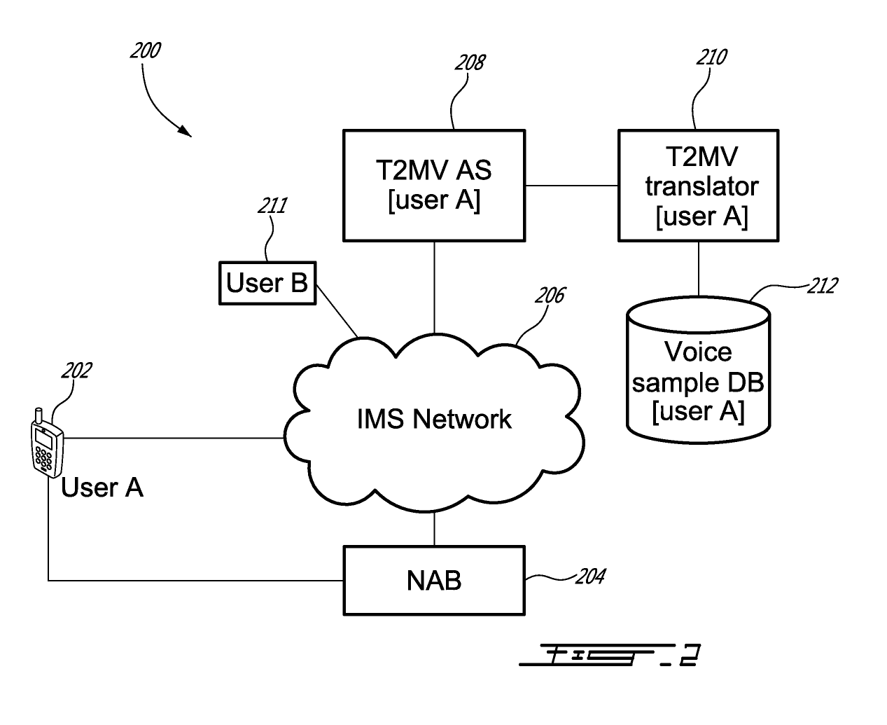

According to one exemplary embodiment, translation of the various message portions of the text into voice is performed locally, i.e., in the end user's terminal. According to another exemplary embodiment, translation of the various message portions of the text into voice is performed in the network. Discussing this network-based translation embodiment first, FIG. 2 illustrates an exemplary network 200 in which the processing of the text message into one or more voices is performed according to one exemplary embodiment. Therein, an end user device 202 is connected to an IMS network 206 and a network address book (NAB) 204 The NAB 204 operates to, among other things, populate the contacts portion of the end user 202's address book user interface as described briefly above, and the operation of the network address book in the context of T2MV services is discussed in more detail below.

The IMS network 206 connects the end user device 202 with that user's T2MV AS 208. T2MV AS 208 is the application server which, according to this exemplary embodiment, implements the logic associated with the T2MV service. For example, the T2MV AS 208 receives the text message that is to be translated to voice from the end user device 202 via the IMS network 206 The T2MV AS 208 extracts each portion of the text from the message, i.e., those text portions which are associated with different contact's voices, and checks the uniform resource indicator (URI) of the T2MV service which is associated with that text portion. If the URI points to the current T2MV service, i.e., the service provided by T2MV AS 208 for user A, then the T2MV AS 208 contacts its T2MV translator 210 to convert that portion into the audio message. To be more efficient, the T2MV AS 208 can first analyze the received text message to group together those text portions which have been associated with the same contact's voice and can then put all of the text portions that use the same contact's voice together into one single request for transmission to the T2MV translator 210.

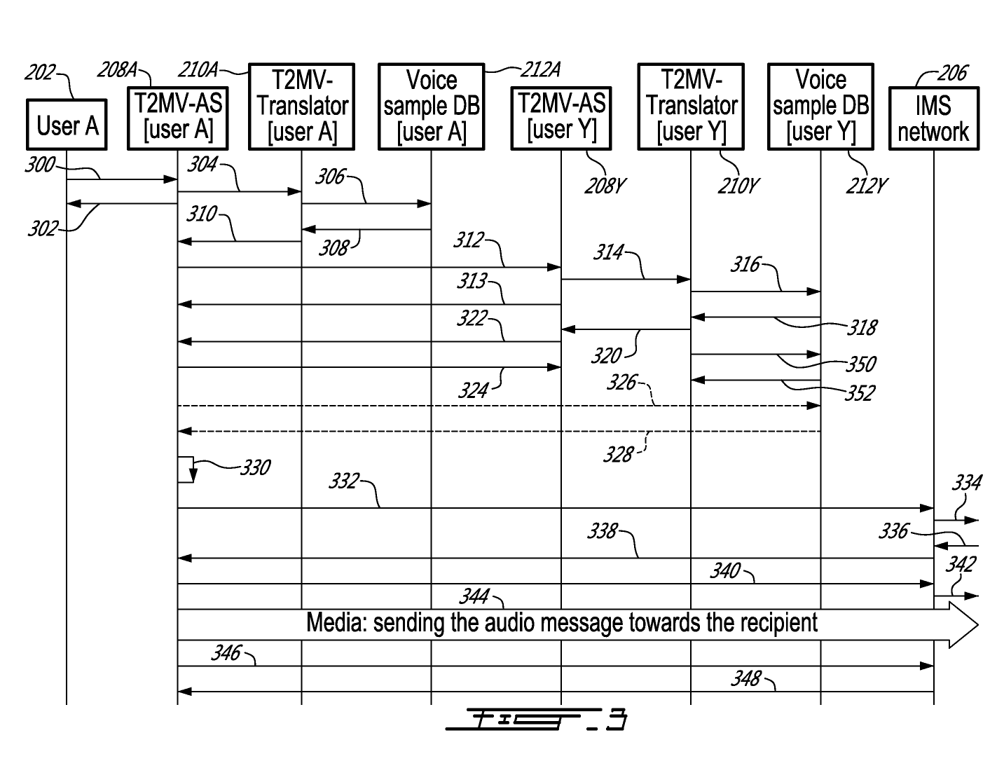

If, on the other hand, the URI associated with a text portion points to a different T2MV service, then the T2MV AS 208 puts that portion of the text into a newly created message request and sends it to that T2MV application, which shall convert the text into the audio message. Moreover, the T2MV AS 208 can also group together all text portions from the text message which have a particular URI for transmission toward the same remote T2MV AS 208 in the same request message. This aspect of forwarding portions of a text message from one T2MV AS 208 to another for processing will be described further with respect to the signaling diagram of FIG. 3 below. Once each text segment of a T2MV message received from user A 202 has been translated into a corresponding voice segment, the T2MV AS 208 can combine these voice segments into a single voice message and deliver that voice message to one or more intended recipients and/or their respective terminals, represented by user B 211, via IMS network 206. Note that although the exemplary embodiments described herein employ an IMS network 206 for delivery of messages between nodes, it will be appreciated by those skilled in the art that any other type of network could alternatively be employed for this purpose.

According to this exemplary embodiment, a voice sample database 212 contains voice samples which can be used by the T2MV translator 210 to synthesize voice segments associated with text portions of a T2MV message. For example, upon receiving a request from the T2MV AS 208, the T2MV translator 210 verifies whether its voice sample database 212 contains samples of the voice(s) of the requested owner of the voice for a given text segment. If so, the T2MV translator 210 retrieves the voice samples based upon the voice owner's identity from the database 212, uses the samples to synthesize speech for that text segment and returns the voice segment to the T2MV AS 208. According to one exemplary embodiment, described in more detail below, the NAB 204 may contain, or provide access to, the voice samples in database 212. The T2MV translator 210 can use any known text-to-voice translation technology to perform this task. Also note that although only one T2MV AS 208, T2MV translator 210, and voice sample database 212 are shown in FIG. 2, according to some exemplary embodiments multiple instances of these entities will be connected to IMS network 206, e.g., associated with different end users. To distinguish between different groups of T2MV AS, T2MV translator and voice sample database combinations, such entities will be referenced using the numbers 208, 210 and 212, respectively, appended with a user letter, e.g., 208A, 210A, 212A, and 208Y, 210Y, 212Y. Also note that elements 208, 210, and 212 can be implemented on a single server or on different servers.

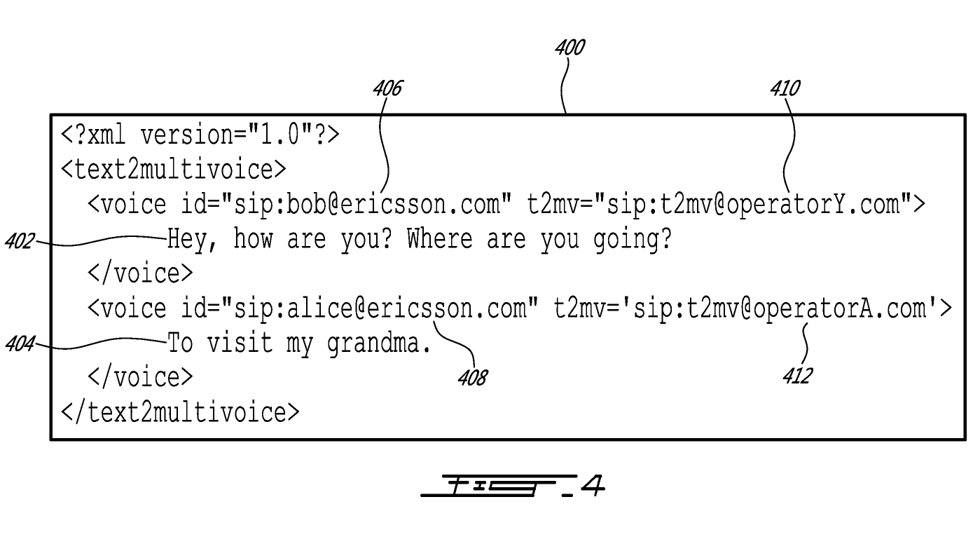

FIG. 3 illustrates signaling according to an exemplary embodiment using the aforedescribed exemplary network 200. Therein, as represented by signal 300, the end user A's device 202 transmits a messaging request to its T2MV service deployed in the network as T2MV-AS 208A via IMS network 206 (e.g., as a CSCF trigger) with the address of the recipient(s). According to an exemplary embodiment, this request signal 300 can be sent as a SIP MESSAGE with an XML body, an example of which is shown in FIG. 4. Therein, an exemplary XML body 400 specifies two text portions 400 and 402 of a T2MV message. Each text portion 402 and 404 has a corresponding contact ID 406, 408, respectively, which identifies whose voice should be used to translate that text portion into an audio segment. Additionally, the XML body 400 of the request message 300 according to this exemplary embodiment includes the URLs 410 and 412 of the T2MV AS 208s associated with each contact ID 406 and 408, respectively. It will be appreciated by those skilled in the art that the XML body 400 of FIG. 4 is purely illustrative and that the request message 300 can convey information for performing translation of text to voice in other formats and provide additional, different or less information. For example, if the transport protocol used for messaging in the network is Hypertext Transport Protocol (HTTP), then XML Configuration Access Protocol (XCAP) can be used for body 400.

Returning to FIG. 3, upon receipt of request message 300, T2MV-AS 208A responds with an acknowledgement message 302. T2MV-AS 208 A parses the request message 300 to determine how many text portions are provided in the T2MV message for voice translation and whether it has the capability to perform each translation itself or whether it needs to forward one or more text portions to other T2MV-AS nodes for translation. In this purely illustrative example, two text portions 402 and 404 are provided in the XML body 400 of message 300, however a request message 300 can contain any number of text portions.

For one of the text portions in this example, i.e., text portion 404, the URI of the T2MV AS in the request message 300 matches that of the T2MV AS 208A of user A. Thus, T2MV AS 208A contacts its T2MV translator 210A by sending signal 304 (including text portion 404 and contact ID 408) which instructs T2MV translator 210A to translate the text portion 404 using the voice associated with contact ID 408. As described above, T2MV translator 210A obtains the voice sample(s) associated with the contact ID 408 from the voice sample database 212A via signals 306 and 308, and then translates the text portion 404 using, in this example, Alice's voice. After the voice translation is completed for text portion 404, a corresponding audio segment is returned to T2MV-AS 208A via signal 310.

If all of the text portions in message 300 have T2MV AS URIs which match that of T2MV AS 208A, then all of the translations could be performed by this application server. However, in this example, the other text portion 402 has a URI 410 associated therewith of a T2MV AS which does not match the URI of T2MV AS 208A. Instead, the URI 410 points toward a different user's (user Y's) T2MV AS 208Y. Thus the other voice which is to be used to translate text portion 402 is available via another user's T2MV service. Accordingly, to translate the text portion 402, the T2MV AS 208A puts the second text portion 402 of the message 300, 400 into another message request 312 and sends that message 312 to T2MV AS 208Y, e.g., via IMS network 206. The T2MV AS 208Y can acknowledge receipt of this task via signal 313. Then, the T2MV AS 208Y contacts its T2V translator 210Y with the text portion 402. In a similar manner to that described above with respect to text portion 404, the T2MV translator 210Y obtains the voice sample(s) corresponding to the contact ID 406 from the voice sample database 212 Y via signals 316 and 318 in order to translate the text portion 402 into a voice segment using Bob's voice, in this example. This audio segment is returned to T2MV AS 208Y via signal 320 and the audio segment (or a reference link to the audio segment that is stored in the network, e.g., in database 212Y via signal 350 and acknowledgement signal 352) is returned to the T2MV AS 208A via signal 322. Acknowledgement of receipt of signal 322 can be provided by T2MV AS 208A via signal 324.

If a link to the voice segment associated with text portion 402 is received by T2MV AS 208A, instead of the actual voice segment itself, then the T2MV AS 208A retrieves the voice segment from the network using the link, as shown by dotted signal lines 326 and 328. Once T2MV AS 208A has obtained voice segments for all of the text portions in the original request message 300, T2MV AS 208A combines (step 330) the audio segments into a single voice message and sends the complete voice message towards the recipient (user B) via IMS network 206. This can be accomplished by, for example, establishing a SIP session via SIP INVITE signals 332, 334, which is accepted via 200 OK signals 336, 338 and acknowledged via signals 340, 342. At this point the media, e.g., a voice message, can be delivered to the user B as indicated by reference numeral 344. Note that delivery of the media can be substantially immediate or can be delayed for a predetermined time period. Once the media has been delivered, the signaling can be completed by handshaking signals 346 and 348.

On the recipient's side, the T2MV service according to exemplary embodiments can, for example, be perceived by the recipient as if the user is receiving a traditional phone call. Thus, the recipient user's device, e.g., mobile phone, landline phone, personal computer, etc. will ring when an audio message which has been generated as described above is being delivered. If the recipient user B picks up the phone call, the audio message is played. If, however, the recipient is not available, the audio message can be stored in the network as, for example, a voice mail or video voice mail. Then, a notification can be sent to the recipient to indicate that a voice mail or video voice mail is stored and ready for the recipient to retrieve.

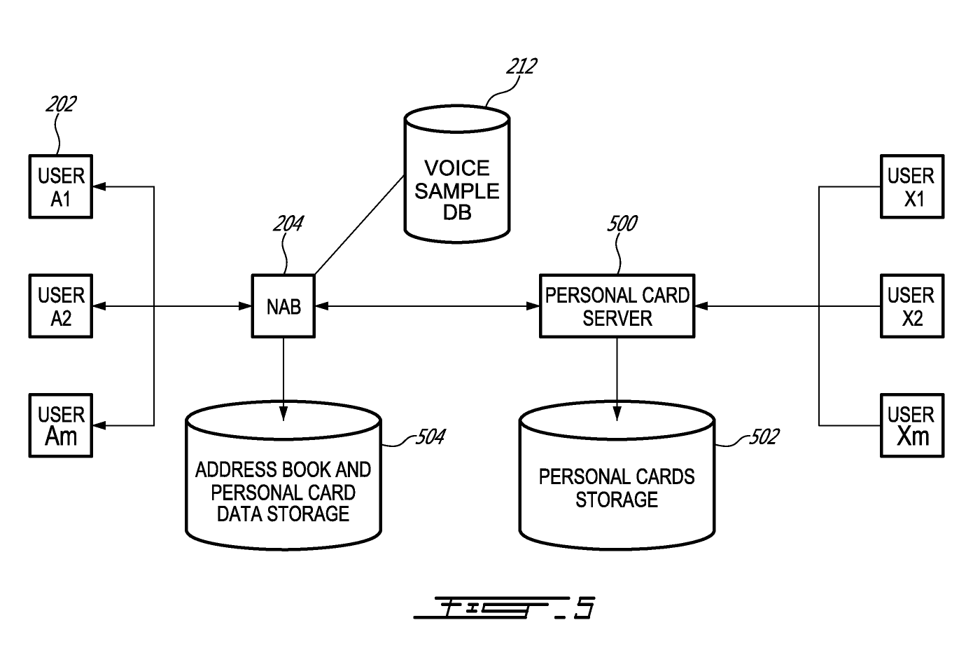

As mentioned above, exemplary embodiments enable users of the T2MV service to mark text portions of a message for voice translation using voices associated with contacts in each user's address book. Information associated with this service can, for example, be distributed by a network address book (NAB) node 204. The NAB 204 may be implemented in a server, for example, so that the user 202 has its address book stored in the network. As shown in FIG. 5, users X1 to Xn store their personal card data in a corresponding personal card server 500 and users X1 to Xn are contacts of users A1 to An. The personal card server 500 may store the personal card data of users X1 to Xn in a personal card storage device 502. Users A1 to An share a NAB server 204 that maintains the network based address book and this NAB server 204 may include address book and personal card data storage device 504. NAB server 204 may communicate with the personal card server 500.

Typically, an end user has two kinds of information associated with network address book implementations, e.g., address book information and Personal Contact Card (PCC) information. The address book information includes information about the end user's contacts, whereas the PCC information is the user's own contact information and may include, for example, the address of the user, a picture, video or any other data determined by the user. If the end user is willing to share his or her voice sample service, according to an exemplary embodiment he or she can include the location of his or her voice sample (or voice sample application server) in his or her PCC and then publish that PCC it to his or her friends. When receiving the PCC, his or her friends can then add that PCC to their address book. According to exemplary embodiments, and of particular interest for the present discussion, such information which is stored in a personal card can include, for example, (1) a voice sample service logo with a flag indicating whether a user permits his or her voice to be used for a free in a T2MV service or whether that user charges a fee for using his or her voice in a T2MV service, and/or (2) a URI associated with a T2MV AS wherein that user's voice sample can be accessed.

In practice, for a user An to receive the personal data of a user X1 from which, for example, the text-to-voice association described above with respect to FIGS. 1(a)-1(c) can be implemented, the following steps can be performed. One or more of users X1 to Xn can send their personal card data including, for example, an indication of whether or under what conditions they permit their voices to be used in a T2MV service and/or the URI associated with the T2MV AS where their voice sample(s) can be accessed, to the personal card server 500. The personal card server 500 stores the data received from the users in the personal cards storing device 502. One or more of the users A1 to An can likewise send contact information to NAB server 204. The users A1 to An can send to NAB 204 a request to subscribe to the personal card data of one or more of users X1 to Xn. NAB 204 stores the contacts in the address book and fetches the personal card data of users X1 to Xn from the personal card server 500. NAB 204 stores that data in the address book and personal card data storage device 504, and notifies one or more of users A1 to An about the received data, e.g., including voice sample data associated with the T2MV service.

Thus end users and network operators can use the architecture of FIG. 5 to provision a T2MV service according to exemplary embodiments. For example, voice samples of voice owners can be obtained by a network operator and populated into the voice sample database(s) 212. Then, entries can be added via the NAB 204 which indicates that the voice owner is willing to offer his or her voice for the T2MV service in that voice owner's Personal Contact Card(s) so that this information is available to end users via their local address books when synchronized with the NAB 204 and can then be used to implement the T2MV service as described above.

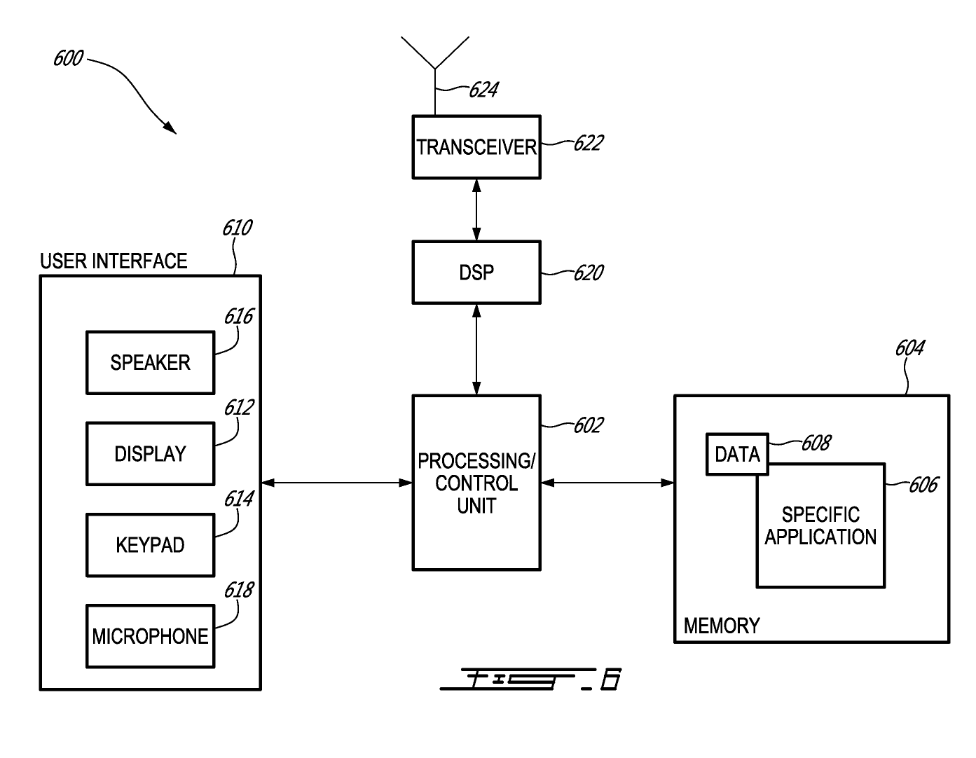

For purposes of illustration and not of limitation, an example of a representative end user terminal device 202 capable of carrying out operations in accordance with the exemplary embodiments is illustrated in FIG. 6. It should be recognized, however, that the principles of the present exemplary embodiments are equally applicable to other terminal devices. The exemplary end user terminal device 600 may include a processing/control unit 602, such as a microprocessor, reduced instruction set computer (RISC), or other central processing module. The processing unit 602 need not be a single device, and may include one or more processors. For example, the processing unit 602 may include a master processor and associated slave processors coupled to communicate with the master processor.

The processing unit 602 may control the basic functions of the end user device 202 as dictated by programs available in the storage/memory 604. Thus, the processing unit 602 may execute the functions associated with exemplary embodiments described above. More particularly, the storage/memory 404 may include an operating system and program modules for carrying out functions and applications on the end user terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the end user terminal computing arrangement 600 via data signals, such as being downloaded electronically via a network, such as the Internet.

One of the programs that may be stored in the storage/memory 604 is a specific application program 606. As previously described, the specific program 606 may interact with the user to enable associations to be generated between portions of a text message and contacts in the user's local address book. The local address book may also be stored in memory 604 and may be synchronized with the NAB server 204. The specific application 606 and associated features may be implemented in software and/or firmware operable by way of the processor 602. The program storage/memory 604 may also be used to store data 608, such as the various associations between text portions and contact voices as described above, or other data associated with the present exemplary embodiments. In one exemplary embodiment, the programs 606 and data 608 are stored in non-volatile electrically-erasable, programmable ROM (EEPROM), flash ROM, etc. so that the information is not lost upon power down of the end user terminal 600.

The processor 602 may also be coupled to user interface elements 610 associated with the end user terminal. The user interface 610 of the terminal may include, for example, a display 612 such as a liquid crystal display, a keypad 614, speaker 616, and a microphone 618. These and/or optionally other user interface components are coupled to the processor 602. The keypad 614 may include alpha-numeric keys for performing a variety of functions, including dialing numbers and executing operations assigned to one or more keys. Alternatively, other user interface mechanisms may be employed, such as voice commands, switches, touch pad/screen, graphical user interface using a pointing device, trackball, joystick, or any other user interface mechanism suitable to implement, e.g., the above-described end user interactions in FIGS. 1(a)-1(c).

The end user terminal 600 may also include a digital signal processor (DSP) 620. The DSP 620 may perform a variety of functions, including analog-to-digital (A/D) conversion, digital-to-analog (D/A) conversion, speech coding/decoding, encryption/decryption, error detection and correction, bit stream translation, filtering, etc. If the end user terminal is a wireless device, a transceiver 622, generally coupled to an antenna 624, may transmit and receive the radio signals associated with the wireless device.

The mobile computing arrangement 600 of FIG. 6 is provided as a representative example of a computing environment in which the principles of the exemplary embodiments described herein may be applied. From the description provided herein, those skilled in the art will appreciate that the present invention is equally applicable in a variety of other currently known and future mobile and fixed computing environments. For example, the specific application 606 and associated features, and data 608, may be stored in a variety of manners, may be operable on a variety of processing devices, and may be operable in mobile devices having additional, fewer, or different supporting circuitry and user interface mechanisms. It should be appreciated that the principles of the present exemplary embodiments are equally applicable to non-mobile terminals, i.e., landline computing systems. It will further be appreciated that such a terminal device 600 thus can include

a memory device 605 configured to store a plurality of contacts, and a processor 602 configured to receive a text message as a first input, a second input which indicates selection of at least one portion of the text message, and a third input which associates a first voice of a first selected contact with the at least one portion of said text message, wherein the processor is further configured to transmit the at least one portion of the text message, information indicating the association between the first voice and the at least one portion of the text message and an identifier of the first selected contact toward an entity for translation of the at least one portion of the text message into at least one audio segment using the first voice

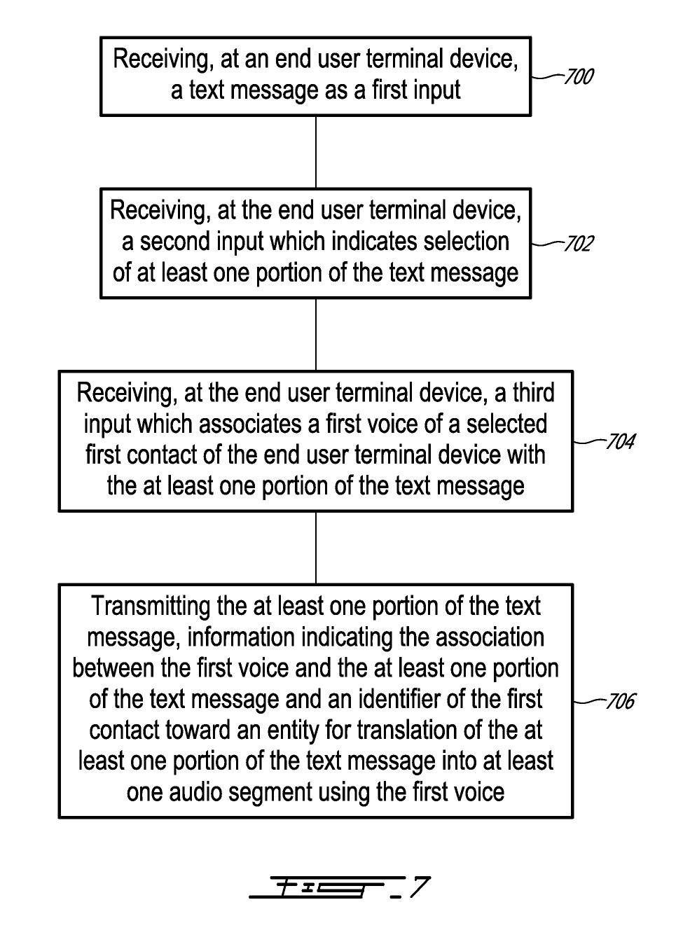

Using, for example, the end user terminal 600, a method for transmitting a text-to-voice message according to an exemplary embodiment is illustrated in the flow chart of FIG. 7. Therein, at step 700, a text message is received at the end user terminal device as a first input. At step 702, the end user terminal also receives a second input which indicates

selection of at least one portion of said text message. A third input is received, at step 704, which associates a first voice of a selected first contact of the end user terminal device with the at least one portion of the text message. Then, at step 706, the end user terminal transmits the at least one portion of the text message, together with information indicating the association between the first voice and the at least one portion of the text message and an identifier of the first contact, toward an entity for translation of the at least one portion of the text message into at least one audio segment using the first voice. It will be appreciated that the method of FIG. 7 is generic to the location where the translation is being performed, e.g., either in the end user terminal itself or in the network. In the case where the translation is being performed locally, then step 706 reflects a conveying of the information gathered from the user interface 610 to a text-to-voice translation function or module within the end user terminal 600 itself. In the case where the translation is being performed in the network, then step 706 reflects transmission of a request message, e.g., toward a T2MV application server 208.

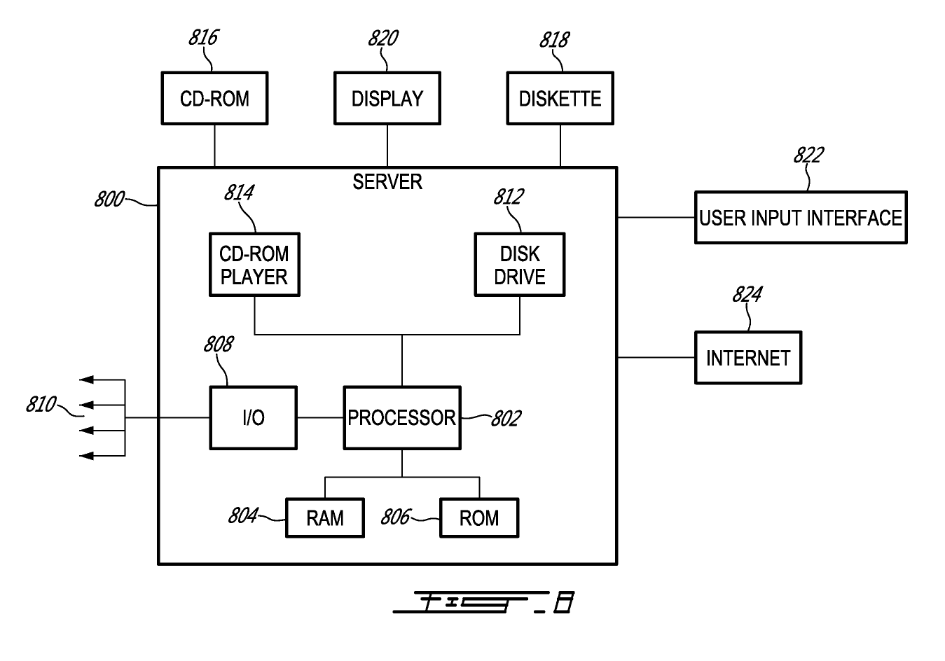

In addition to end user terminals, exemplary embodiments also impact network nodes, e.g., application servers and NAB servers, and FIG. 8 provides an exemplary representation thereof. Therein, server 800 includes a central processor (CPU) 802 coupled to a random access memory (RAM) 804 and to a read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like.

The server 800 may also include one or more data storage devices, including hard and floppy disk drives 812, CD-ROM drives 814, and other hardware capable of reading and/or storing information such as DVD, etc. In one embodiment, software for carrying out the above discussed steps and signal processing may be stored and distributed on a CD-ROM 816, diskette 818 or other form of media capable of portably storing information. These storage media may be inserted into, and read by, devices such as the CD-ROM drive 814, the disk drive 812, etc. The server 800 may be coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The server 800 may be coupled to other computing devices, such as the landline and/or wireless terminals and associated watcher applications, via a network. The server 800 may be part of a larger network configuration as in a global area network (GAN) such as the Internet 824, which allows ultimate connection to the various end user devices, e.g., landline phone, mobile phone, personal computer, laptop, etc. When operating as a T2MV application server according to exemplary embodiments, server 800 performs the afore-described functions of T2MV message request handling and assembly, i.e., it retrieves the information from the received request, locates where to translate the text (local or remote server), constructs the new request towards the remote T2MV (if any), then assembles the audio messages from the response and delivers it to the recipient. According to one embodiment, a text-to-multi-voice translation server includes a database configured to store voice samples, an interface configured to receive a request message from a user for translating a text message into a voice message, the request message including: (a) a first text portion;

(b) an identity of a first contact of said user whose first voice is to be used to translate the first text portion, (c) a second text portion, and (d) an identity of a second contact of the user whose second voice is to be used to translate the second text portion, and a processor configured to obtain, responsive to the request message, a voice message including a first voice portion corresponding to the first text portion using the first voice associated with the first contact, and a second voice portion corresponding to the second text portion using the second voice associated with the second contact.

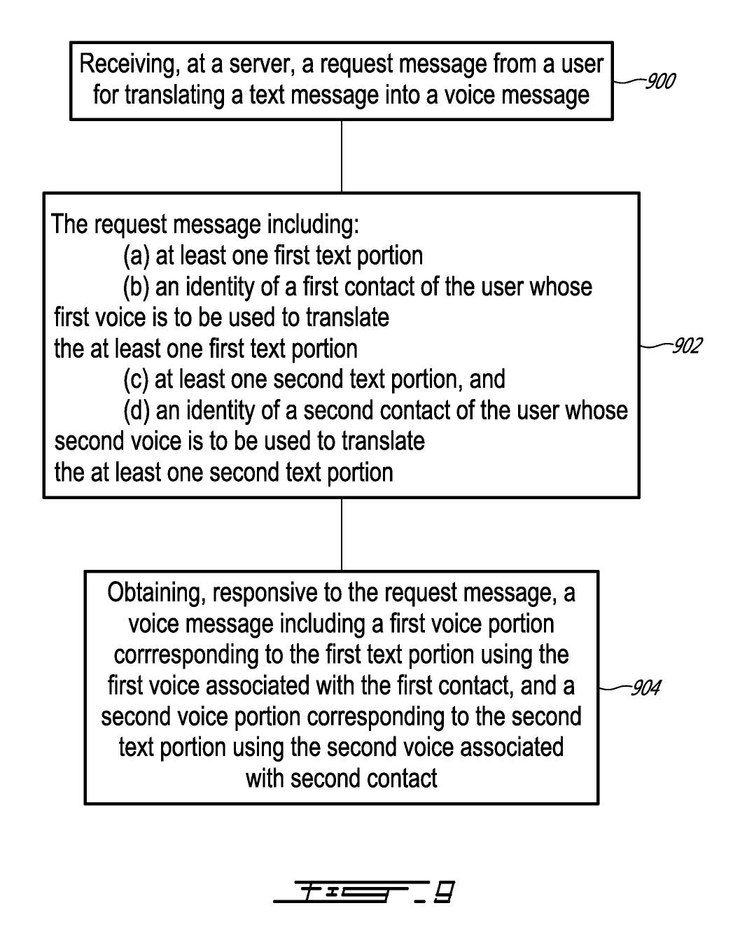

When used as a T2MV application server 208, the structure illustrated in FIG. 8 can, for example, be operated to process a text-to-voice message as shown in the flow chart of FIG. 9. Therein, at step 900, a request message is received by the server from a user for translating a text message into a voice message. As shown in block 902, the request message includes: (a) a first text portion, (b) an identity of a first contact of the user whose first voice is to be used to translate the first text portion, (c) a second text portion, and

(d) an identity of a second contact of the user whose second voice is to be used to translate the second text portion. The server can obtain, responsive to the request message at step 904, a voice message including a first voice portion corresponding to the first text portion using the first voice associated with the first contact, and a second voice portion corresponding to the second text portion using the second voice associated with second contact.

In addition to end user terminals and servers, systems and methods for processing data according to exemplary embodiments of the present invention can be implemented as software, e.g., performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

Numerous variants of text-to-multi-voice services are described herein. The text message can be translated into voice by the end user terminal at the sending/originating side. In such an exemplary embodiment, the sending device can be responsible for retrieving all of the selected voice samples from the voice owners or operator network, converting the text message to the audio message and delivering the audio message to the recipient(s) directly. According to another exemplary embodiment, the text message can be translated into voice by the end user device at the receiving/terminating side. In such an exemplary embodiment, all of the text message with the information about the voice samples needed for translation is delivered to the recipient's terminal. Based upon the interaction from the recipients, the recipient's terminal device can retrieve all of the selected voice samples and store them in the terminal. Then the recipient's end user terminal can convert the text message into the audio message and output that message to the recipient. According to another exemplary embodiment, a hybrid solution involving both a terminal device and the network can be used to perform the translation. For example, the T2MV translator 210 can perform the actual translation based upon receipt of commands from either the originating terminal or recipient terminal via a network-to-network interface (NNI) which allows the terminal device to access the T2MV translator 210.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for transmitting a text-to-voice message comprising:
receiving, at an end user terminal device, a text message as a first input;
receiving, at said end user terminal device, a second input which indicates selection of at least one portion of said text message;
receiving, at said end user terminal device, a third input which associates a first voice of a selected first contact of said end user terminal device with said at least one portion of said text message; and
transmitting said at least one portion of said text message, information indicating said association between said first voice and said at least one portion of said text message and an identifier of said first contact toward an entity for translation of said at least one portion of said text message into at least one audio segment using said first voice.

2. The method of claim 1, wherein said entity for translation is one of:
(a) a text-to-voice translation module disposed in said end user terminal device, (b) a network-based text-to-voice translation application server, and (c) an end user recipient device of said text-to-voice message.

3. The method of claim 1, wherein said step of transmitting further comprises:
transmitting said text message including said at least one portion, said information indicating said association between said first voice and said at least one portion of said text message and said identifier of said first selected contact toward said entity for translation of said at least one portion of said text message into an audio segment using said first voice.

4. The method of claim 1, further comprising:
receiving, at said end user terminal device, a fourth input which indicates selection of another at least one portion of said text message; and
receiving, at said end user terminal device, a fifth input which associates a second voice of a selected second contact of said end user terminal device with said another at least one portion of said text message.

5. The method of claim 4, said step of transmitting further comprises:
transmitting said at least one portion of said text message, said information indicating said association between said first voice and said at least one portion of said text message and an identifier of said selected first contact, and said information indicating said association between said second voice and said another at least one portion of said text message and said identifier of said selected second contact, toward said entity for translation of said at least one portion of said text message into at least one audio segment using said first voice and said another at least one portion of said text message into another at least one audio segment using said second voice.

6. The method of claim 4, the step of transmitting further comprising:
transmitting said at least one portion of said text message, said information indicating said association between said first voice and said at least one portion of said text message, said identifier of said selected first contact, and a uniform resource indicator (URI) of said first text-to-voice translation application server and said information indicating said association between said second voice and said another at least one portion of said text message, said identifier of said second contact, and another uniform resource indicator (URI) of said first text-to-voice translation application server, toward said entity for translation of said at least one portion of said text message into at least one audio segment using said first voice and said another at least one portion of said text message into another at least one audio segment using said second voice.

7. The method of claim 2, wherein said entity is a text-to-voice translation module disposed within said end user terminal device, said method further comprising:
retrieving voice samples associated with said first voice and said second voice;
translating said at least one portion of said text message into said at least one audio segment using at least one voice sample associated with said first voice;
translating said another at least one portion of said text message into said another at least one audio segment using at least one voice sample associated with said second voice;
combining said at least one audio segment with said another at least one audio segment to generate a voice message, and
transmitting said voice message toward at least one recipient.

8. A terminal device comprising:
a memory device configured to store a plurality of contacts; and
a processor configured to receive a text message as a first input, a second input which indicates selection of at least one portion of said text message, and a third input which associates a first voice of a first selected contact with said at least one portion of said text message,
wherein said processor is further configured to transmit said at least one portion of said text message, information indicating said association between said first voice and said at least one portion of said text message and an identifier of said first selected contact toward an entity for translation of said at least one portion of said text message into at least one audio segment using said first voice.

9. The terminal device of claim 8, wherein said entity for translation is one of:
(a) a text-to-voice translation module disposed in said end user terminal device, (b) a network-based text-to-voice translation application server, and (c) an end user recipient device of said text-to-voice message.

10. The terminal device of claim 8, wherein said processor is further configured to transmitting said text message including said at least one portion, said information indicating said association between said first voice and said at least one portion of said text message and said identifier of said first selected contact toward said entity for translation of said at least one portion of said text message into an audio segment using said first voice.

11. The terminal device of claim 8, wherein said processor is further configured to receive a fourth input which indicates selection of another at least one portion of said text message, and a fifth input which associates a second voice of a second selected contact with said another at least one portion of said text message.

12. The terminal device of claim 8, wherein said processor is further configured to transmit said at least one portion of said text message, said information indicating said association between said first voice and said at least one portion of said text message and said identifier of said first selected contact, and information indicating said association between said second voice and said another at least one portion of said text message and an identifier of said second selected contact, toward said entity for translation of said at least one portion of said text message into at least one audio segment using said first voice and said another at least one portion of said text message into another at least one audio segment using said second voice.

13. The terminal device of claim 8, the processor being further configured to transmit said at least one portion of said text message, said information indicating said association between said first voice and said at least one portion of said text message, said identifier of said first selected contact, and a uniform resource indicator (URI) of said first text-to-voice translation application server and said information indicating said association between said second voice and said another at least one portion of said text message, said identifier of said second selected contact, and another uniform resource indicator (URI) of said first text-to-voice translation application server, toward said entity for translation of said at least one portion of said text message into at least one audio segment using said first voice and said another at least one portion of said text message into another at least one audio segment using said second voice.

14. The terminal device of claim 9, wherein said entity is a text-to-voice translation module configured to operate within said terminal device by retrieving voice samples associated with said first voice and said second voice, translating said at least one portion of said text message into said at least one audio segment using at least one voice sample associated with said first voice, and translating said another at least one portion of said text message into said another at least one audio segment using at least one voice sample associated with said second voice,
wherein said processor is further configured to combine said at least one audio segment with said another at least one audio segment to generate a voice message and to transmit said voice message toward at least one recipient.

15. A method for processing a text-to-voice message comprising:
receiving, at a server, a request message from a user for translating a text message into a voice message, said request message including:
(a) at least one first text portion;
(b) an identity of a first contact of said user whose first voice is to be used to translate said at least one first text portion;
(c) at least one second text portion; and
(d) an identity of a second contact of said user whose second voice is to be used to translate said at least one second text portion; and
obtaining, responsive to the request message, a voice message including a first voice portion corresponding to the first text portion using said first voice associated with the first contact, and a second voice portion corresponding to the second text portion using said second voice associated with second contact.

16. The method of claim 15, further comprising the steps of:
translating said first text portion into said first voice portion in said first voice and said second text portion into said second voice portion in said second voice;
combining, at said server, said first voice portion and said second voice portion into said voice message; and
transmitting, by said server, said voice message toward at least one recipient.

17. The method of claim 16, wherein said step of translating is also performed by said server using a local text-to-voice translation function and a local database of stored voice samples.

18. The method of claim 15, the method further comprising:
identifying, by said server, one of said first text portion and said second text portion as being translatable at another server;
transmitting, by said server, said identified one of said first text portion and said second text portion, a respective one of said first contact and said second contact and an identity of said another server; and
receiving, by said server, a respective one of said first voice portion and said second voice portion from said another server.

19. The method of claim 15, wherein said request message includes a uniform resource indicator (URI) for each text portion which indicates where a respective text portion is translatable into a corresponding voice.

20. A text-to-multi-voice translation server comprising:
a database configured to store voice samples;
an interface configured to receive a request message from a user for translating a text message into a voice message, said request message including:
(a) a first text portion;
(b) an identity of a first contact of said user whose first voice is to be used to translate said first text portion;
(c) a second text portion; and
(d) an identity of a second contact of said user whose second voice is to be used to translate said second text portion; and
a processor configured to obtain, responsive to the request message, a voice message including a first voice portion corresponding to the first text portion using said first voice associated with the first contact, and a second voice portion corresponding to the second text portion using said second voice associated with the second contact.

21. The text-to-multi-voice translation server of claim 20, wherein said processor is further configured to translate said first text portion into said first voice portion in said first voice and said second text portion into said second voice portion in said second voice, to combine said first voice portion and said second voice portion into said voice message, and to transmit said voice message toward at least one recipient.

22. The text-to-multi-voice translation server of claim 21, wherein said processor is further configured to retrieve voice samples from said voice sample database using said identities of said first contact and said second contact.

23. The text-to-multi-voice translation server of claim 21, wherein said processor performs each of said translations locally.

24. The text-to-multi-voice translation server of claim 21, wherein said processor is further configured to determine whether each of said translations can be performed locally by identifying whether one of said first text portion and said second text portion is translatable at another server, to transmit said identified one of said first text portion and said second text portion, a respective one of said first contact and said second contact and an identity of said another server, and to receive a respective one of said first voice portion and said second voice portion from said another server.

25. The text-to-multi-voice translation server of claim 21, wherein said request message includes a uniform resource indicator (URI) for each text portion which indicates where a respective text portion is translatable into a corresponding voice.

26. A database stored on a computer system, comprising:
an address book containing a plurality of contacts, at least one contact including contact information having one or more voice samples associated with the contact.

27. The database of claim 26, wherein the computer system is a user terminal.

28. The database of claim 26, wherein the computer system is a network server.

29. The database of claim 26, wherein said contact information further includes a uniform resource indicator (URI) pointing toward a text-to-voice application server which is capable of translating text using said one or more voice samples.

30. The database of claim 26, wherein said contact information further includes information associated with whether said at least one contact charges a fee for usage of his or her voice in a text-to-voice service.
